(19) United States
(12) Patent Application Publication
(10) Pub. No.: US 2003/0202062 A1
(43) Pub. Date: Oct. 30, 2003

(54) Configurable ink supply system

(76) Inventors: Charles R. Steinmetz, Corvallis, OR (US); Ronald R. Anderson, Corvallis, OR (US); Raul Perez, San Diego, CA (US); Mark McGarry, San Diego, CA (US); David Berardelli, San Diego, CA (US)

Correspondence Address: HEWLETT PACKARD COMPANY, Intellectual Property Administration, P.O. Box 272400, Fort Collins, CO, 80527-2400, US

(21) Appl. No.: 10/133,916

(22) Filed: Apr. 25, 2002

(51) Int. Cl. B41J 2/14

(52) U.S. Cl. 347/86; 347/49

(57) ABSTRACT

Apparatuses, methods, systems, and arrangements enable a modular and/or adaptable ink supply system for printing devices. In certain implementations base ink containers having ink couplings are designed for use individually or grouped together with a carrier. Ink cartridges of various sizes and purposes may therefore be manufactured and operationally employed utilizing one or more substantially identical base ink containers. In certain (alternative but non-exhaustive) implementations, a carrier may include a lid that serves to aid retention of the base ink containers against the carrier and/or to facilitate the use of the ink couplings of the base ink containers. Additionally, an ink cartridge, with one or multiple base ink containers, may optionally employ a single memory chip apparatus for utilization of intelligent printing functions. Those ink cartridges with multiple base ink containers may hold a single hue of ink or multiple different hues of ink.

### BACKGROUND

The technical field relates in general to printing, and in particular to modular and adaptable fluid systems for ink supplies of ink-based printing devices.

Ink-based printing devices are used in many different types of printing environments. For example, ink-jet printers are used in stand-alone environments attached to an individual computer. Ink-jet printers are also used in networked environments as a printing device utilized by a number of network clients and attached thereto via a network connection. As another example of an ink-based printing device, ink-using web printers are capable of printing many “pages” of text and graphics from a single roll of paper, which may then be cut into separate or groups of pages for subsequent formation into a newspaper, a newsletter, etc. These ink printers may print using black, color, or black and color inks. Conventional ink printers are designed for use with conventional ink supplies, which are typically formed of contiguous ink containers having dividers therein to form separately volumed compartments for different hues of ink.

FIG. 1A illustrates schematically at 100 conventional single-hue ink containers. Specifically, four (4) unequal-sized containers 105, 110, 115, and 120 are illustrated. The containers 105, 110, 115, and 120 may, for example, be used in an ink-based web printer under different usage demands. For example, the container 105 may be used for lighter usage demands while the container 120 may be used for heavier usage demands. Depending on usage demands and the size of the container 105, 110, 115, and 120, the operator may need to frequently replace the ink container of a webprinter engaged in an ink-intensive print.

FIG. 1B illustrates schematically at 150 a conventional multi-hue ink container. The exemplary container 150 includes three (3) equal-sized compartments 155. Each of the three equal-sized compartments 155 may hold a different hue of ink. For example, the three compartments 155 may hold cyan ink, magenta ink, and yellow ink. Typically, the container 150 is replaced separately from, although perhaps contemporaneously with, another container holding black ink (not shown).

Previous ink supplies, such as the single-hue and multi-hue containers discussed above, have typically involved dedicated configurations for each printer type, requiring redesign of the containers, retooling of manufacturing lines, and maintaining separate inventories of each supply configuration.

### SUMMARY

Apparatuses, methods, systems, and arrangements as described herein enable a modular and adaptable ink supply system for printing devices. In certain implementations, for example, base ink containers having ink couplings are designed for use individually or grouped together with a carrier. Ink cartridges of various sizes and purposes may therefore be manufactured and operationally employed utilizing one or more substantially identical base ink containers. In certain implementations, a carrier may include a lid that serves to aid retention of the base ink containers against the carrier and to facilitate the use of the ink couplings of the base ink containers. Additionally, an ink cartridge, with one or multiple base ink containers, may optionally employ a single memory chip apparatus for utilization of intelligent printing functions, e.g., when the ink cartridge is mounted on and interfaced with a printing device. Those ink cartridges with multiple base ink containers may hold a single hue of ink or multiple different hues of ink. Methods of manufacturing an ink supply system, as well as the packaging thereof with printing devices, are also described herein.

### BRIEF DESCRIPTION OF THE DRAWINGS

Exemplary implementations are best understood by referring to FIGS. 2-9 of the Drawings, like numerals being used for like and/or corresponding features, aspects, and components of the various drawings.

FIG. 1A illustrates conventional prior art single-hue ink containers.

FIG. 1B illustrates a conventional prior art multi-hue ink container.

FIG. 2 is a block diagram that illustrates various exemplary components of an exemplary multifunction printing device.

FIG. 3A illustrates a first exemplary single-hue ink container implementation.

FIG. 3B illustrates a first exemplary multi-hue ink container implementation.

FIG. 4A is a key defining various symbols illustrated in FIGS. 4B-4H.

FIG. 4B illustrates an exemplary ink jet cartridge interface for the print unit of FIG. 2.

FIG. 4C illustrates a second exemplary multi-hue ink container implementation.

FIG. 4D illustrates a perspective view of a third exemplary multi-hue ink container implementation having an exemplary carrier.

FIG. 4E illustrates a frontal view of the third exemplary multi-hue ink container implementation.

FIG. 4F illustrates a top view of the third exemplary multi-hue ink container implementation.

FIG. 4G illustrates a top view of an exemplary lid for the third exemplary multi-hue ink container implementation.

FIG. 4H illustrates a bottom view of the exemplary lid for the third exemplary multi-hue ink container implementation.

FIG. 5A is a key defining various symbols illustrated in FIGS. 5B-5H.

FIG. 5B illustrates another exemplary ink jet cartridge interface for the print unit of FIG. 2.

FIG. 5C illustrates a second exemplary single-hue ink container implementation.

FIG. 5D illustrates a perspective view of a third exemplary single-hue ink container implementation.

FIG. 5E illustrates a frontal view of the third exemplary single-hue ink container implementation having another exemplary carrier.

FIG. 5F illustrates a top view of the third exemplary single-hue ink container implementation.

FIG. 5G illustrates a top view of an exemplary lid for the third exemplary single-hue ink container implementation.

FIG. 5H illustrates a bottom view of the exemplary lid for the third exemplary single-hue ink container implementation.

FIG. 6A illustrates a top view of a fourth exemplary multi-hue ink container implementation having another exemplary carrier.

FIG. 6B illustrates a top view of a fourth exemplary single-hue ink container implementation having another exemplary carrier.

FIG. 7A illustrates an exemplary method in flowchart form for communicating with a memory of an exemplary multi-hue ink container implementation.

FIG. 7B illustrates an exemplary method in flowchart form for communicating with a memory of an exemplary single-hue ink container implementation.

FIG. 8 illustrates an exemplary method in flowchart form for constructing an exemplary ink supply system.

FIG. 9 illustrates an exemplary method in flowchart form for manufacturing exemplary ink supply systems.

FIGS. 10A-10C are isometric views further illustrating an exemplary embodiment of the invention, in which five discrete ink containers are configured within a carrier.

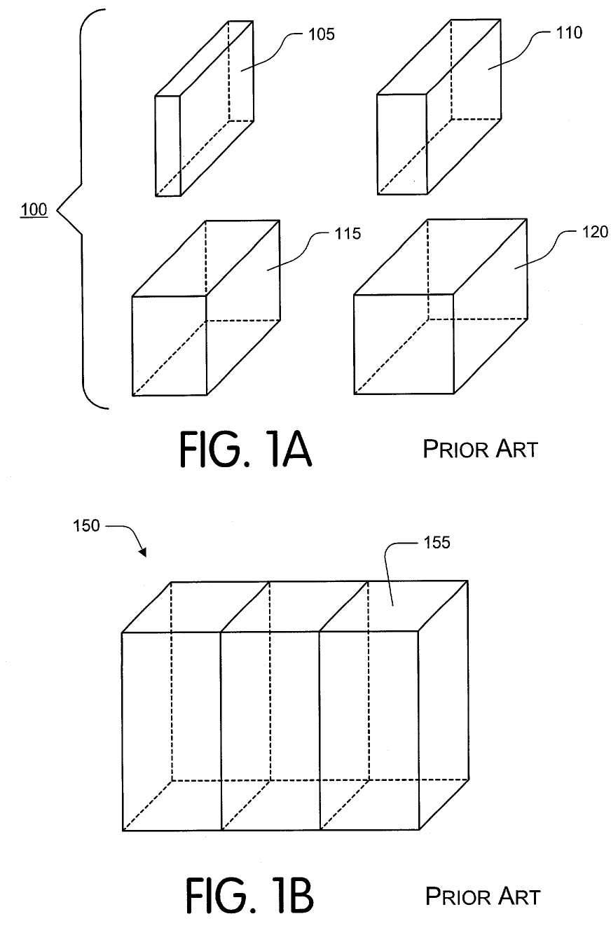

### DETAILED DESCRIPTION

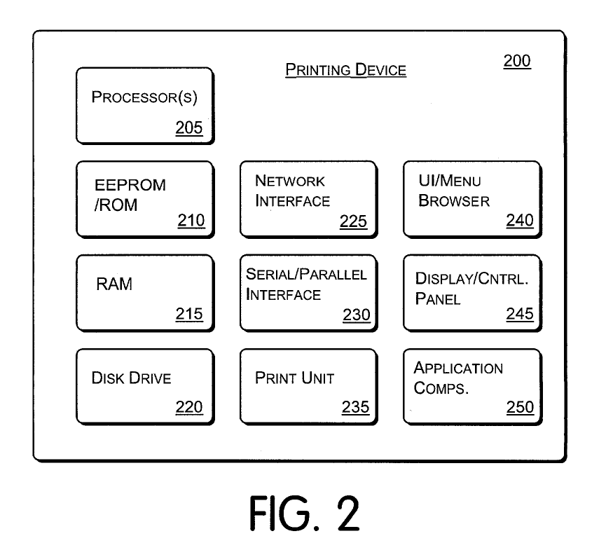

FIG. 2 is a block diagram illustrating various typical components of an exemplary multifunction printing device at 200. A multifunction device, as the name implies, is a device capable of multiple functions which are related, but not necessarily limited, to one or more of the following functions: printing; copying; scanning, including image acquisition and text recognition; sending and receiving faxes; print media handling; and/or data communication, either by print media or e-media, such as via email or electronic fax. It should be noted that a multifunction printing device need not include other function(s) beyond that of printing. In other words, a “printing device” may (but need not necessarily) have other features in addition to printing, such as copying, scanning, faxing, etc.

The printing device 200 may include one or more processors 205, an electrically erasable programmable read-only memory (EEPROM) and/or read-only (non-erasable) memory (ROM) 210 and a random access memory (RAM) 215.

The processors 205 process various instructions to control the operation of the printing device 200 and optionally to communicate with other electronic and computing devices. The memory components (e.g., EEPROM and/or ROM 210, RAM 215, etc.) store various information and/or data such as configuration information, fonts, templates, print data, scanned image data, and menu structure information, depending on the functions provided by and being used with the printing device 200.

The printing device 200 may also include a disk drive 220, a network interface 225, and a serial and/or parallel interface 230. The disk drive 220 provides additional storage for data being printed, copied, scanned, and/or faxed, or other information maintained by or for the printing device 200.

A network interface 225 may provide a connection between the printing device 200 and a data communication network (or a specific device connected over a network-type medium). The network interface 225 allows devices coupled to a common data communication network to send print jobs, faxes, menu data, and other information to printing device 200 via the network. Similarly, the serial and/or parallel interface 230 may provide a data communication path directly between the printing device 200 and another electronic or computing device.

The printing device 200 may also include a print unit 235 that includes mechanisms arranged to selectively apply ink to a print media such as paper, plastic, fabric, and the like in accordance with print data corresponding to a print job. For example, the print unit 235 may include an ink jet printing mechanism that selectively causes liquid ink to be extracted from ink containers and ejected from print heads through nozzles and onto print media to form an intended pattern (e.g., text, pictures, etc.).

The printing device 200 may also optionally include a user interface (UI) or menu browser 240 and a display and control panel 245. The UI or menu browser 240 allows a user of the printing device 200 to navigate the device's menu structure. A control aspect of the display and/or control panel 245 may be composed of indicators or a series of buttons, switches, or other selectable controls that are manipulated by a user of the printing device 200.

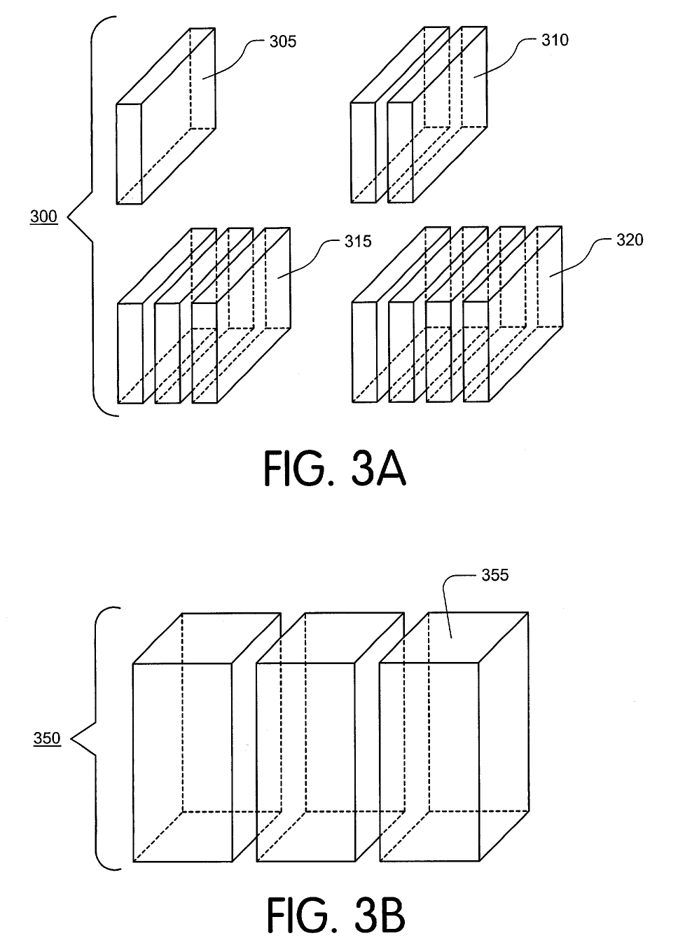

FIG. 3A illustrates generally at 300 a first exemplary single-hue ink container implementation. The first exemplary single-hue ink container implementation 300 includes four (4) exemplary single-hue ink container sets 305, 310, 315, and 320. The single-hue ink container set 305 includes one (1) container of a given size. The single-hue ink container set 310 includes two (2) containers of the given size. The single-hue ink container set 315 includes three (3) containers of the given size, and the single-hue ink container set 320 includes four (4) containers of the given size. Because each individual container may be of approximately the same volume (e.g., the given size), each individual container may be constructed from the same forms/molds/etc. on the same assembly line. When a number of the individual containers are grouped into the four (4) exemplary single-hue ink container sets 305, 310, 315, and 320, four (4) differently-sized single-hue ink containers are effectively formed thereby using one or more of the base single-sized individual containers. For example, the four (4) exemplary single-hue ink container sets 305, 310, 315, and 320 may be of volume “V”, volume “2V”, volume “3V”, and volume “4V”, respectively. It should be understood that other base volumes, that other physical shape configurations of the base container, and that more than four (4) base containers may be alternatively employed. Consequently, environments having different ink supply demands may be responsively satisfied using variable-volume, single-hue ink container sets built from multiple single-fixed-volume base containers.

FIG. 3B illustrates generally at 350 a first exemplary multi-hue ink container implementation. The first exemplary multi-hue ink container implementation 350 includes three (3) exemplary individual containers 355. Each of the three individual containers 355 may be of a volume “V”, and each of the three (3) individual containers 355 may hold ink of a different color. The three (3) exemplary individual containers 355 do not share any walls in common. Thus, because each of the three (3) individual containers 355 (which may also be similarly or identically shaped) are separate containers, the individual containers 355 may be utilized in a non-grouped implementation. In other words, many individual base containers 355 may be produced using, e.g., one schematic and a single production facility. With this system, some of the individual containers 355 may be packaged separately while other of the individual containers 355 may be grouped together (e.g., into groups of three (3), five (5), etc.) onto a carrier and thereafter packaged.

It should be noted that the described volume “V” of FIGS. 3A and 3B need not be the same volume. It should be understood that other base volumes, that other physical shape configurations of the base container, and that more than three (3) base containers may alternatively be employed. For example, the individual base containers may be cubicle in shape, and the number of base containers grouped together may be five (5). Consequently, environments that may be better served with individual multi-hue ink supplies as well as environments that may be better served with grouped multi-hue ink supplies may both be served using the same adaptable base container. Additionally, it should be noted that either of FIGS. 3A and 3B, as well as the related text above, may also be applied to fixer inks. Furthermore, fixer ink(s) may be grouped with single-hue or multi-hue ink supplies (e.g., onto a single carrier).

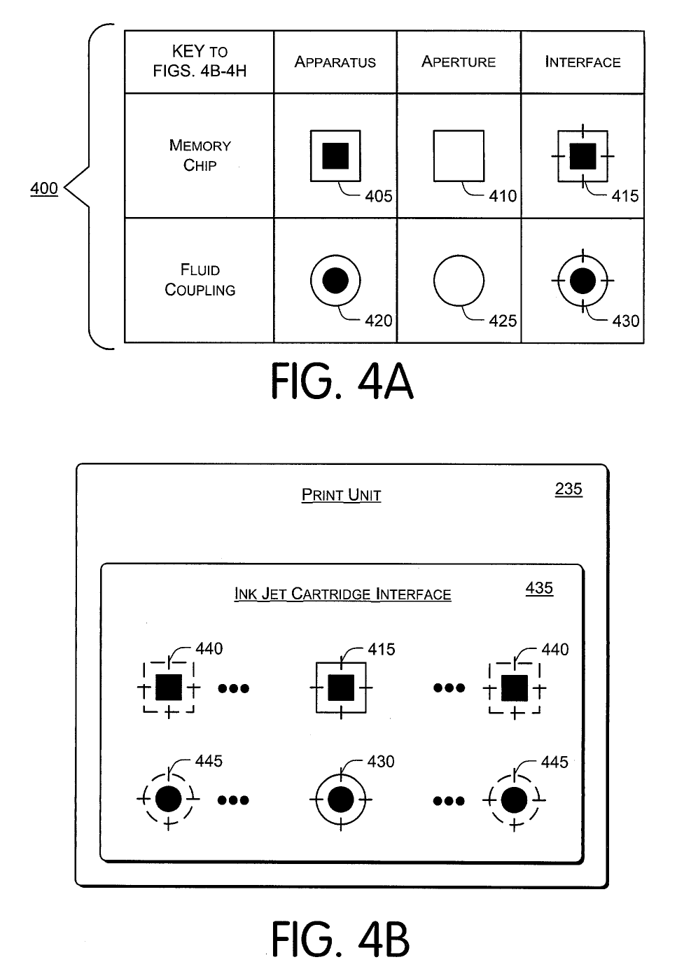

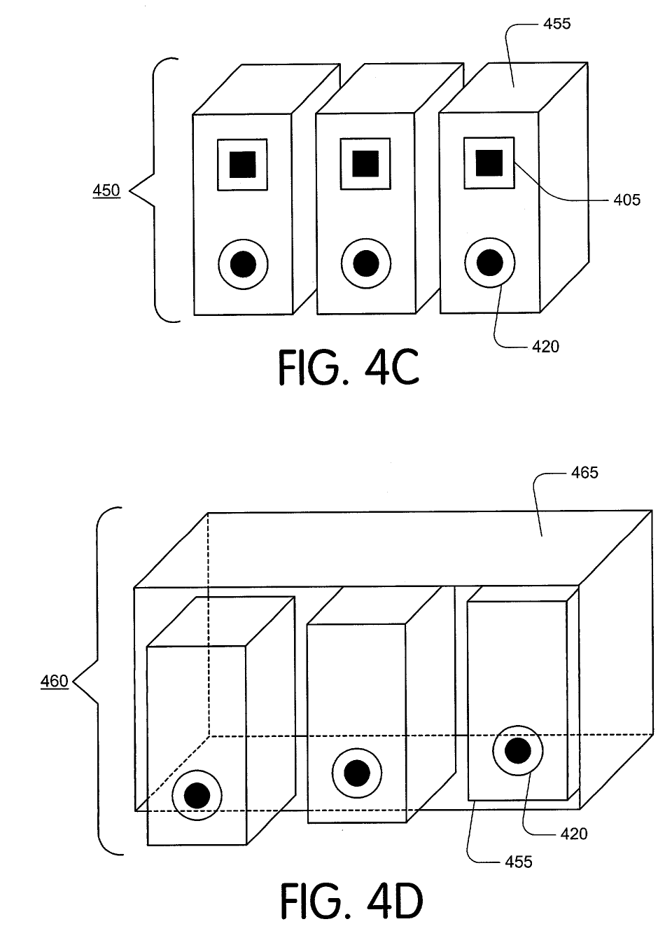

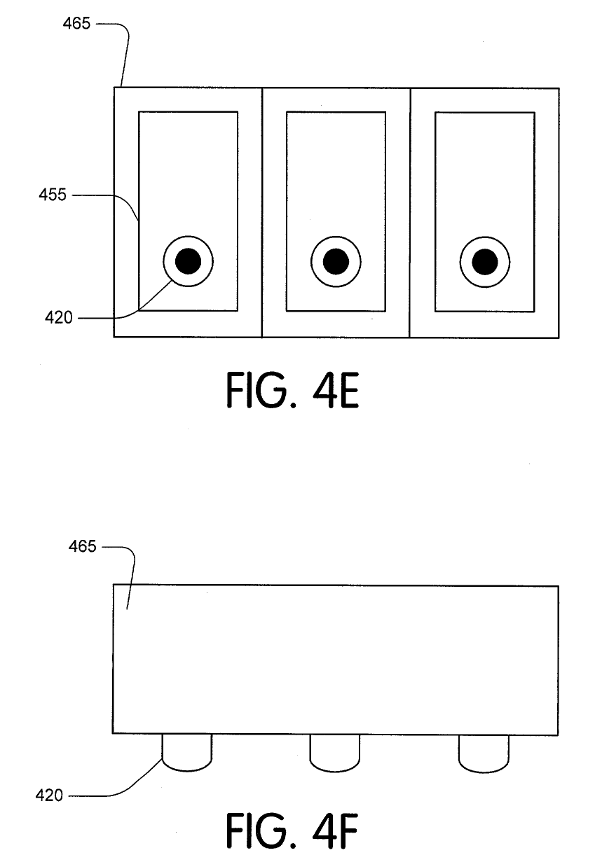

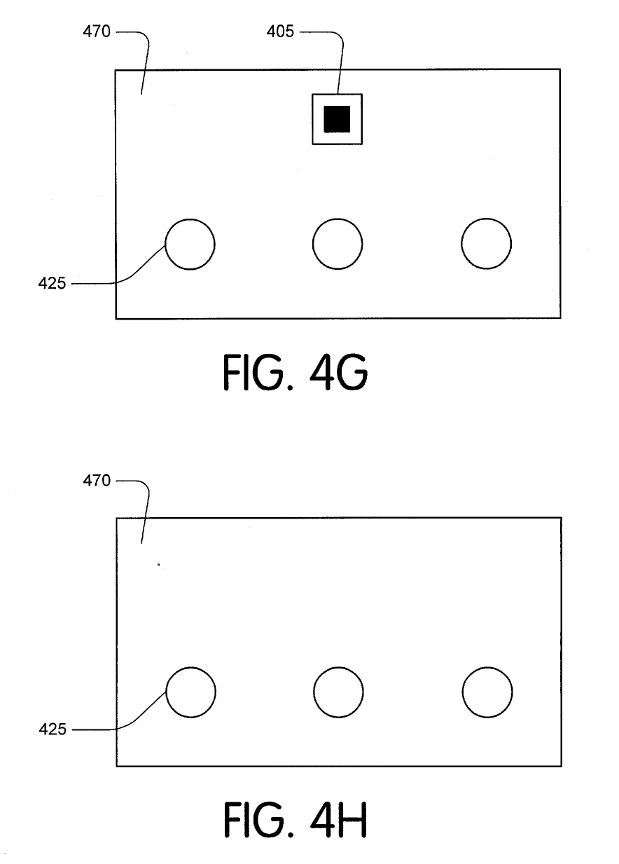

FIG. 4A is a key denoted generally by 400 that defines various symbols illustrated in FIGS. 4B-4H. FIGS. 4B-4H relate primarily, but not exclusively, to exemplary multi-hue ink container implementations. These implementations involve one or more memory chips and multiple fluid couplings, which are described further herein. In FIGS. 4B-4H, an apparatus, an aperture, and/or an interface version of each of the memory chips and fluid couplings may be represented. Specifically, symbols for a memory chip apparatus 405, a memory chip aperture 410, and a memory chip interface 415 are provided in the key 400. The key 400 also provides symbols for a fluid coupling apparatus 420, a fluid coupling aperture 425, and a fluid coupling interface 430.

FIG. 4B illustrates an exemplary ink jet cartridge interface at 435 for the print unit of FIG. 2. The print unit 235 (of the exemplary printing device 200) includes an exemplary ink jet cartridge interface 435. The ink jet cartridge interface 435 may include a memory chip interface 415 and a fluid coupling interface 430. The memory chip interface 415 enables the print unit 235 to interact with a memory chip apparatus 405 (not shown in FIG. 4B). For example, the print unit 235 (e.g., under the control of the application components 250, for example) may read data from or write data to a memory chip apparatus 405 via the memory chip interface 415. Likewise, the fluid coupling interface 430 enables the print unit 235 to interact with a fluid coupling apparatus 420 (also not shown in FIG. 4B). For example, the print unit 235 may cause ink (e.g., in the form of droplets) to be extracted from a fluid coupling apparatus 420 via the fluid coupling interface 430.

The ink jet cartridge interface 435 may optionally include additional memory chip interface(s) 440 and/or additional fluid coupling interface(s) 445. For instance, if the exemplary printing device 200 is intended to print using three (3) colors plus black ink, then the ink jet cartridge interface 435 may be designed with four (4) each of the memory chip interfaces and the fluid coupling interfaces. If, on the other hand, the exemplary printing device 200 is intended to print using five (5) colors plus black ink, then the ink jet cartridge interface 435 may be designed with six (6) each of the memory chip interfaces and the fluid coupling interfaces. It should be noted that the ink jet cartridge interface 435 may be designed with other numbers of interfaces and that there may be a different number of memory chip interface(s) than fluid coupling interfaces.

Application of certain principle(s) enables both grouped and individual ink supplies to have many common parts and/or manufacturing systems. An ink supply system may be designed such that base containers are configurable for both grouped and individual purposes to thereby meet the demands of various particular customer segments and price points. The base containers may be packaged and sold as individual supplies or ganged together into, and held by, a carrier that may be packaged and sold as grouped supplies. Consequently, such application may enable lower cost products, may ease adjustment to marketplace changes, and may add flexibility to an ink supply strategy.

FIG. 4C illustrates generally at 450 a second exemplary multi-hue ink container implementation. The second exemplary multi-hue ink container implementation 450 includes three (3) ink containers 455. The three (3) ink containers 455 each include a memory chip apparatus 405 and a fluid coupling apparatus 420. The memory chip apparatus 405 may be used to store data such as information related to the ink contained within the ink container 455. For example, the memory chip apparatus 405 may store the hue of the ink (e.g., which color ink or whether it is black ink), the level/amount of the ink in the ink container 455, time/time periods (e.g., when the ink container was manufactured, when the ink container was first used, when the ink container was last used, etc.), etc. With respect to ink hue, the ink hue may be, for example, (i) cyan, magenta, yellow, light-cyan, light-magenta, or black for a five (5)-color, six (6)-ink supply; (ii) cyan, magenta, yellow, or black for a three (3)-color, four (4)-ink supply; etc. Alternatively, orange and/or green inks may be included, especially in commercial printing environments. With respect to level/amount of the ink, the level/amount may be indicated by storing, for example, (i) the ink level (e.g., depth of the ink based on an inductive coil measuring technique, which is described further herein), (ii) the number of drops extracted from the ink container 455 (perhaps in conjunction with the original ink volume, the volume of each drop, etc.), (iii) the actual ink volume, etc. It should be understood that the term “memory chip” need not be limited to an integrated circuit; the term “memory chip” may represent, embrace, and include electrical, magnetic, electromagnetic, optical memory storage devices, etc. in general, such as a magnetic stripe or strip, flash memory, a plastic film with memory locations/cells, and so forth.

The fluid coupling apparatus 420 may include only a fluid port for extracting ink from the ink container 455 (e.g., when the ink is held within a bag or other collapsible device within the ink container 455). Alternatively, the fluid coupling apparatus 420 may include an ink outlet and an air inlet (e.g., when the ink is held within a solid, non-collapsible container). It should be understood that the fluid coupling apparatus 420 may alternatively be composed of and/or include other element(s) either alone or in combination. The second exemplary multi-hue ink container implementation 450 illustrates base containers configured optionally for individual sale (e.g., a trade ink supply configuration for customer refill flexibility) inasmuch as each ink container 455 includes a memory chip apparatus 405. Hence, they may be packaged and sold separately while still maintaining the ability to utilize intelligent printing features based on the stored data for each individual ink hue. However, reducing the number of memory chip apparatuses 405 can reduce the total cost for a multi-hue ink supply implementation. Therefore, an exemplary printing device 200, and the print unit 235 therefore and the corresponding ink jet cartridge interface 435 thereof, may be designed to also accept grouped ink supplies (e.g., a host ink supply configuration for a low-cost initial bundling with a new printer, a low-cost refill option, etc.). Such a design enables a printer manufacturer to adjust to customer demand between grouped and individual ink supply configurations without redesigning a product or its manufacturing equipment.

FIG. 4D illustrates generally at 460 a perspective view of a third exemplary multi-hue ink container implementation having an exemplary carrier. The perspective view of the third exemplary multi-hue ink container implementation 460 illustrates an exemplary grouped ink supply configuration. The grouped ink supply configuration includes a carrier 465 and three (3) ink containers 455. It should be noted that the number of ink containers 455 may be different from three (3). Each of the ink containers 455 includes a fluid coupling apparatus 420. The ink containers 455 are illustrated as being inserted into the “front” of the carrier 465, which may have a different physical shape than the particular shape illustrated in the perspective view of the third exemplary multi-hue ink container implementation 460.

FIG. 4E illustrates a frontal view of the third exemplary multi-hue ink container implementation. The frontal view of the third exemplary multi-hue ink container implementation illustrates three (3) ink containers 455 residing within the carrier 465, along with a fluid coupling apparatus 420 disposed on each of the ink containers 455. The carrier 465 may include, in certain implementation(s), physical features on the inside (or elsewhere depending on the physical shape of the carrier) to aid in positioning each ink container 455 relative to each other ink container 455 and to the specific and correlating interfaces of the ink jet cartridge interface 435 (of FIG. 4B) so that the, e.g., three (3) fluid coupling apparatuses 420 properly and appropriately line up for installation and operation therewith.

Such physical features may extend along the entire or almost the entire height of the carrier 465 (as illustrated in FIG. 4E), may only extend along a portion of the full height (e.g., at both ends, along the middle, etc.), may be located fully or partially “behind” the ink containers 455 (e.g., so as to contact the ink containers 455 on a side opposite the fluid coupling apparatuses 420), may be located at either or both the “floor” and “ceiling” of the carrier 465, some combination thereof, etc. Many alternative physical feature implementations may be employed in addition to or instead of those shown and described. For example, instead of or in addition to, the physical features may be more than mere guides and may actually enable the ink containers 455 to “snap” into/onto the carrier 465.

FIG. 4F illustrates a top view of the third exemplary multi-hue ink container implementation. The top view of the third exemplary multi-hue ink container implementation illustrates how the fluid coupling apparatuses 420 of the ink containers 455 (not explicitly shown in FIG. 4F) may extend beyond the confines of the main portion of the carrier 465. While such a design is not necessary for all implementations, this design enables the fluid coupling apparatuses 420 to extend beyond fluid coupling apertures in a lid (which are illustrated in FIGS. 4G and 4H) of the carrier 465. It should be noted that the fluid coupling interfaces 430 and 445 (of FIG. 4B) of the ink jet cartridge interface 435 may alternatively (or additionally) be designed to extend into the body of the main portion of the carrier 465, thus obviating any need for the fluid coupling apparatuses 420 to extend beyond the body of the main portion of the carrier 465.

FIG. 4G illustrates a top view of an exemplary lid 470 for the third exemplary multi-hue ink container implementation. The top view of the exemplary lid 470 for the third exemplary multi-hue ink container implementation illustrates a manner or part of a manner for the three (3) ink containers 455 to remain maintained within the carrier 465 while still permitting an interfacing with the ink jet cartridge interface 435 (of FIG. 4B). The lid 470 may include three (3) fluid coupling apertures 425 and one (1) memory chip apparatus 405. The lid 470 may be secured above the three (3) ink containers 455 and onto the top of the carrier 465 (e.g., as illustrated in FIG. 4E and described as the “front” of the carrier 465 in text related thereto). The lid 470 and the carrier 465 may be realized, in certain implementation(s), in plastic or a similar material, and they may be fastened together by any one or more of many techniques that are known in the art, such as snaps, welds, adhesives, etc. It should be understood that the term “lid” is merely descriptive of one possible interpretation of the specific implementation(s) illustrated in FIGS. 4B-4H and is therefore used to illuminate principles and not to be limiting.

For example, two (2) parts that together form a carrier may be equal sized, with neither part therefore necessarily appearing to meet the definition of a “lid”. As another example, a carrier “main” portion such as element 465 may be designed to secure the ink containers 455 thereto by snap, adhesive, weld, etc. with a second part to be attached thereto being merely large enough to support a memory chip apparatus 405 in one planar direction and to extend across the carrier 465 in the other planar direction. Other exemplary carrier designs are described herein. Continuing with the lid 470 (of FIG. 4G), it should be noted that a lid, or other “secondary” carrier portion, may be obviated by placing a memory chip apparatus 405 directly on one of the ink containers 455 (e.g., as would be done if the ink container were destined for individual use), such as any center ink container 455. The lid 470 includes a memory chip apparatus 405 that may be disposed on the top surface thereof for interfacing with the memory chip interface 415 of the ink jet cartridge interface 435 (of FIG. 4B). It should be noted that the memory chip apparatus 405 need not be placed in the center of the lid 470 (or the center ink container 455), for it may be placed anywhere in which there is a corresponding memory chip interface 415 or 440 of the ink jet cartridge interface 435.

In such an implementation as lid 470, the memory chip apparatus 405 may be designed to store data regarding multiple ink containers and multiple ink colors (or even ink hues in implementation(s) in which the black ink is grouped with the colored inks). For example, a data structure on the memory chip apparatus 405 may be organized in a listing and according to color, with each color having appropriate information such as ink amount/level. An exemplary printing device 200 may therefore perform intelligent printing functions for all colors (or hues) using a single memory chip apparatus 405. The printing functions can be effectuated using the fluid coupling apparatuses 420 because they are designed to be accessible through the fluid coupling apertures 425 of the lid 470.

FIG. 4H illustrates a bottom view of the exemplary lid 470 for the third exemplary multi-hue ink container implementation. The bottom view of the exemplary lid 470 for the third exemplary multi-hue ink container implementation illustrates that, e.g., three (3) fluid coupling apertures 425 are positioned on the lid 470 to enable the three (3) fluid coupling apparatuses 420 of the ink containers 455 to extend therethrough (and/or for the three corresponding fluid coupling interfaces 430 and 445 to extend therethrough). When securing the lid 470 to the main portion of the carrier 465, the “bottom” of the lid may be positioned toward the ink containers 455 (e.g., as they are illustrated in FIG. 4E) so that the memory chip apparatus 405 on the “top” of the lid may be exposed and accessible to the memory chip interface 415 of the ink jet cartridge interface 435 (of FIG. 4B).

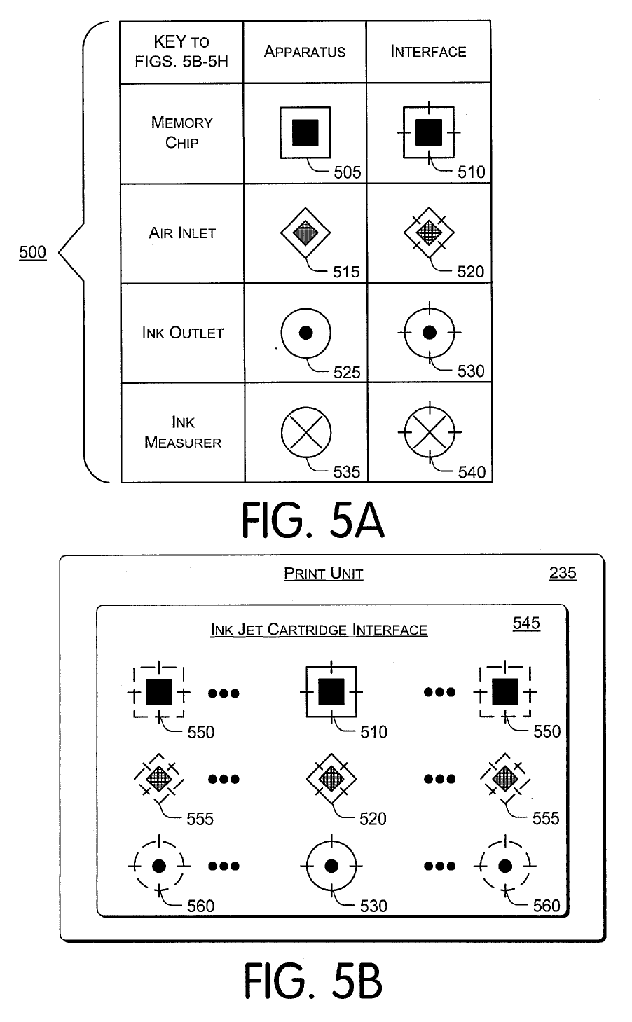

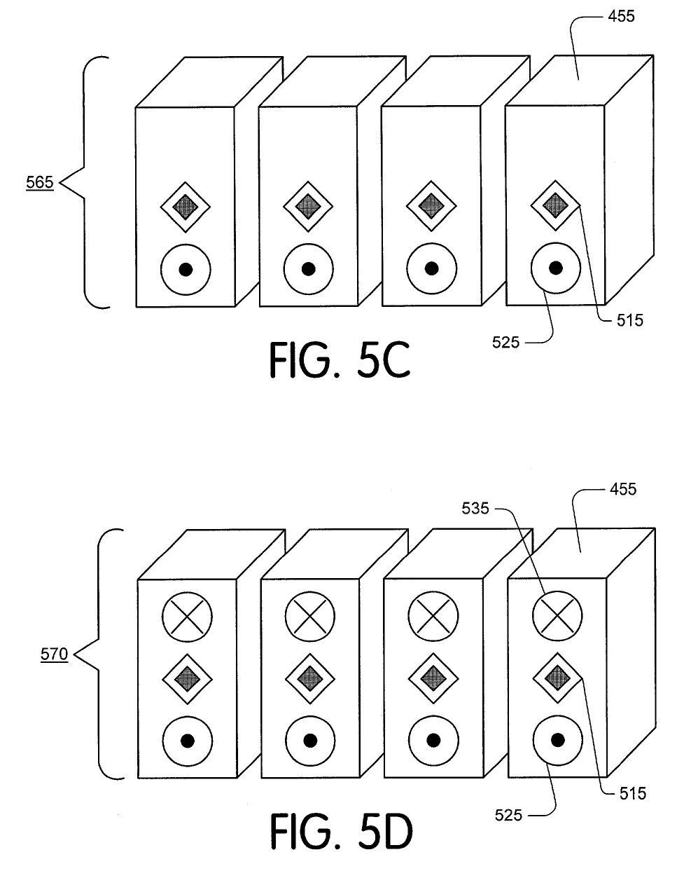

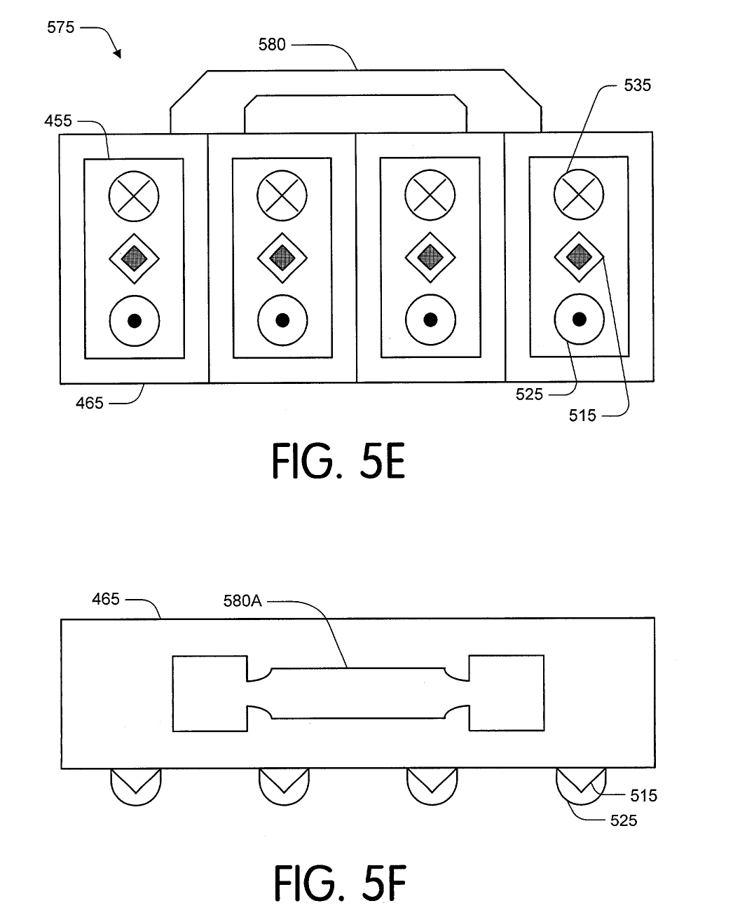

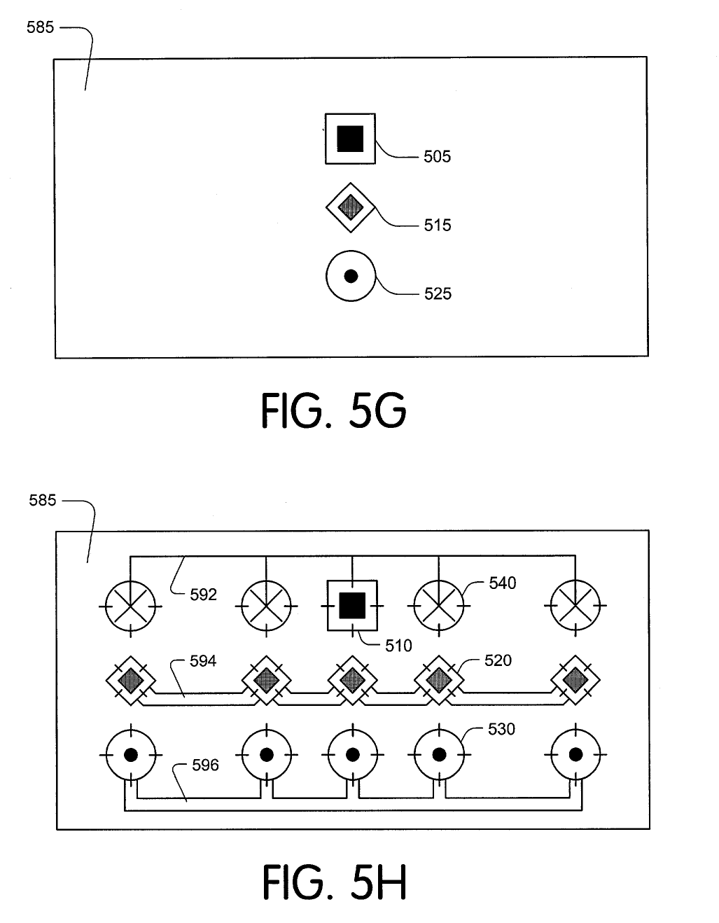

FIG. 5A is a key denoted generally by 500 that defines various symbols illustrated in FIGS. 5B-5H. FIGS. 5B-5H relate primarily, but not exclusively, to exemplary single-hue ink container implementations. These implementations involve one or more memory chips, one or more air inlets, one or more ink outlets, and one or more ink measurers, which are described further hereinbelow. In FIGS. 5B-5H, an apparatus and/or an interface version of each of the memory chips, air inlets, ink outlets, and ink measurers may be represented. Specifically, symbols for a memory chip apparatus 505, an air inlet apparatus 515, an ink outlet apparatus 525, and an ink measurer apparatus 535 are provided in the key 500. The key 500 also provides symbols for a memory chip interface 510, an air inlet interface 520, an ink outlet interface 530, and an ink measurer interface 540.

FIG. 5B illustrates another exemplary ink jet cartridge interface at 545 for the print unit of FIG. 2. The print unit 235 (of the exemplary printing device 200) includes an ink jet cartridge interface 545. The ink jet cartridge interface 545 may include a memory chip interface 510, an air inlet interface 520, and an ink outlet interface 530. The memory chip interface 510, the air inlet interface 520, and the ink outlet interface 530 enable the print unit 235 to interact with a memory chip apparatus 505, an air inlet apparatus 515, and an ink outlet apparatus 525 (the latter three (3) of which are not shown in FIG. 5B). It should be noted that air inlet(s) need not be employed in single-hue ink container implementations, but separate air inlet(s) and ink outlet(s) are illustrated and described in this context to more fully explain another example of a fluid coupling, which is a more general concept and term. It should also be noted that the memory chip apparatus (505) of FIGS. 5A-5H is assigned a different element number from that of the memory chip apparatus (405) of FIGS. 4A-4H only to reflect that the data stored therein is likely to differ, for there need be no actual physical difference. For example, a memory chip apparatus 405 may have various hue (e.g., color) indications stored therein that are additionally associated with specific ink containers 455 while a memory chip apparatus 505 may only have a single hue (e.g., black) indication stored therein that is associated with all ink containers 455 instead of a specific one.

The ink jet cartridge interface 545 may optionally include additional memory chip interface(s) 550, additional air inlet interface(s) 555, and/or additional ink outlet interface(s) 560. For instance, if the exemplary printing device 200 is intended for a higher-output job environment, then the ink jet cartridge interface 545 may be designed with five (5) each of the memory chip interfaces, the air inlet interfaces, and the ink outlet interfaces. If, on the other hand, the exemplary printing device 200 is intended for a lower-output job environment, then the ink jet cartridge interface 545 may be designed with three (3) each of the memory chip interfaces, the air inlet interfaces, and the ink outlet interfaces. It should be noted that the ink jet cartridge interface 545 may be designed with other numbers of interfaces and that there may be a different number of memory chip interface(s) than air inlet and ink outlet interfaces. For example, an ink jet cartridge interface 545 may be designed with a single memory chip interface (e.g., on one side or the other, at or near the center, etc.) and six (6) air inlet/ink outlet interface pairs. Furthermore, a corresponding memory chip apparatus 505 may be designed to inform the print unit 235 of the number of ink containers 455 (e.g., from one (1) to six (6)) that are present to enable a user to select the number of desired ink containers 455 for a given task, phase, or time period to thereby further increase the expandability, flexibility, and/or adaptability of single-hue ink container implementation(s).

Application of certain principle(s) enables ink supplies of varying total volume to have many common parts and/or manufacturing systems with the grouping of base ink containers. An ink supply system may be designed such that base containers are configurable for various grouping levels and purposes to thereby meet the demands of various customer segments and corresponding ink demands. Web-based printers, or those printers that print onto large rolls of paper, can consume huge quantities of ink in short periods of time. Keeping the ink refilled can require frequent attention from a user of the printer. Nevertheless, not all customers want the largest ink container that can possibly be lifted by a human as printing needs vary. Therefore, in accordance with certain implementation(s), differing numbers of base containers may be grouped together with a carrier and packaged and sold in volumes corresponding to multiples of the volume of the base container. Consequently, such flexibility may enable modular and scalable products, may provide for easier configuration of an ink supply having an effective ink volume required or preferred for a specific printing application, and/or may reduce the time and/or frequency required for an operator to replace consumed ink cartridges in a printer with new ink cartridges.

FIG. 5C illustrates generally at 565 a second exemplary single-hue ink container implementation. The second exemplary single-hue ink container implementation 565 includes an exemplary four (4) ink containers 455, although it should be understood that more or fewer ink containers 455 may be grouped together with a carrier. Each of the ink containers 455 includes an air inlet apparatus 515 and an ink outlet apparatus 525. It should be noted that defining the air and ink ports as “inlet” and “outlet”, respectively, from the perspective of the ink container 455 is arbitrary and intended to aid explanation and not to be limiting. It is equivalent to define them as “outlet” and “inlet”, respectively, from the perspective of the ink jet cartridge interface 545. Additionally, there is a further equivalency because some implementations of fluid couplings may operate such that ink and air may be sent both in and out of the ink containers; in other words, the direction of fluid flow may reverse through the fluid couplings during operation. In the second exemplary single-hue ink container implementation 565, ink level/amount may be determined and/or recorded based on, for example, counting expelled droplets of ink.

FIG. 5D illustrates generally at 570 a perspective view of a third exemplary single-hue ink container implementation. The perspective view of the third exemplary single-hue ink container implementation 570 also includes an exemplary four (4) ink containers 455. Each of the ink containers 455 may include both an air inlet apparatus 515 and an ink outlet apparatus 525 as well as an ink measurer apparatus 535. In the third exemplary single-hue ink container implementation 570, ink level/amount may be determined and/or recorded based on, for example, the ink measurer apparatus 535. The ink measurer apparatus 535 may be realized using any known apparatus and/or technique for measuring the ink level/amount. For example, inductive coils may be employed where the inductive coils collapse as ink is used. It should be understood that one or more ink measurer apparatuses may be utilized in any of the multi-hue ink container implementations described or suggested herein, and/or otherwise contemplated hereby.

FIG. 5E illustrates generally at 575 a frontal view of the third exemplary single-hue ink container implementation having another exemplary carrier. The frontal view of the third exemplary single-hue ink container implementation 575 includes a carrier 465 with a handle 580. The handle 580 may be used to lift, carry, lower, install, remove, etc. the carrier 465, along with the four (4) ink containers 455. It should be noted that the handle 580 may be attached to a different location/side of the carrier 465 (including any lid (not explicitly illustrated in FIG. 5E) thereof); that the handle may be attached at a different angle; that the handle may be shaped differently than the exemplary handle 580 as illustrated in the third exemplary single-hue ink container implementation 575; that the handle may be composed of any of many materials (e.g., plastic) and need not be of a material identical to that of the carrier; that the handle may be integral (e.g., molded of the same material) with the carrier or permanently or removably attached thereto; etc. It should be understood that a handle may be incorporated into any of the multi-hue ink container implementations described or suggested herein, and/or otherwise contemplated hereby. Each of the ink containers 455 as illustrated includes an ink measurer apparatus 535, an air inlet apparatus 515, and an ink outlet apparatus 525. The carrier 465 may include physical features for maintaining the ink containers 455 in a desired fixed relationship as described and explained hereinabove with reference to the multi-hue ink container implementation(s).

FIG. 5F illustrates a top view of the third exemplary single-hue ink container implementation. The top view of the third exemplary single-hue ink container implementation illustrates the carrier 465 and the handle 580A attached thereto (or integrated therewith). It should be noted that the handle 580A illustrates an alternative physical structure for a handle of the carrier 465. The top view of the third exemplary single-hue ink container implementation also illustrates how the ink outlet apparatuses 525 and the air inlet apparatuses 515 of the ink containers 455 (not explicitly shown in FIG. 5F) may extend beyond the confines of the main portion of the carrier 465. While such a design is not necessary for all implementations, this design enables (but is not required for) the ink outlet apparatuses 525 and the air inlet apparatuses 515 to extend beyond the top, bottom and sides of the carrier 465. They may extend, for example, through apertures in a lid (not shown in the third exemplary single-hue ink container implementation), to one or more interfaces therefore (as illustrated in FIGS. 5B and 5H), etc. It should be noted that the ink measurer apparatuses 535 (not explicitly shown in FIG. 5F) may also extend beyond the confines of the main portion (or the lid) of the carrier 465.

FIG. 5G illustrates a top view of an exemplary lid 585 for the third exemplary single-hue ink container implementation. The top view of the exemplary lid 585 for the third exemplary single-hue ink container implementation illustrates how multiple ink containers 455 may be “combined” into a carrier such that the ink jet cartridge interface 545 (of FIG. 5B) may interact with the multiple ink containers 455 through only one each of a memory chip apparatus 505, an air inlet apparatus 515, and an ink outlet apparatus 525. Hence, after the lid 585 is secured to the main portion of the carrier 465 (e.g., as illustrated in FIG. 5E), the ink jet cartridge interface 545 may interact with the four (4) ink containers stored in the carrier 465 via only one each of a memory chip interface 510, an air inlet interface 520, and an ink outlet interface 530 (of FIG. 5B). (An alternative implementation may be created by having one (or more) memory chip apparatuses 505 on the top of the lid 585 and a set of apertures for the air inlet apparatuses 515 and the ink outlet apparatuses 525 (and optionally the ink measurer apparatuses 535).)

FIG. 5H illustrates a bottom view of the exemplary lid 585 for the third exemplary single-hue ink container implementation. The bottom view of the exemplary lid 585 for the third exemplary single-hue ink container implementation illustrates a pair of common manifolds (e.g., pipes, chambers, passages, etc.) for the two fluid ports and a common interface for ink measurement. The bottom of the lid 585 includes four (4) ink measurer interfaces 540 to interface with the four (4) ink measurer apparatuses 535 (as illustrated in FIGS. 5D and 5E). The four (4) ink measurer interfaces 540 are connected via a bus 592 to a memory chip interface 510. This memory chip interface 510 may be designed to interact with the memory chip apparatus 505 on the top side of the lid 585 (e.g., to store and/or forward measured data) and to control the flow of signals over the bus 592 (e.g., by sequentially testing each ink measurer apparatus 535 via the corresponding ink measurer interface 540. It should be noted that the memory chip interface 510 of the lid 585 (of FIG. 5H) may differ from the memory chip interface 510 of the ink jet cartridge interface 545 (of FIG. 5B).

A number of alternatives may be employed for the exemplary lid 585, particularly with respect to the four (4) ink measurer interfaces 540 and the bus 592. To wit, the bus (or more generally line) 592 may be a single lead (e.g., that is capable of electromagnetic signal propagation, etc.) or it may be a more complex bus. Furthermore, the four (4) ink measurer interfaces 540 (and/or any such four (4) individual memory chip apparatuses 505) need not necessarily be connected to a single memory chip 505 (e.g., on the top view of the exemplary lid 585 (of FIG. 5G)). For example, the bus 592 may alternatively pass through the lid 585 (omitting memory chip interface(s) 510) to thereby enable the ink jet cartridge interface 545 to directly measure the ink level/amount (e.g., via inductance) one container 455 at a time, jointly across all containers 455 at once, etc. As another alternative, the ink jet cartridge interface 545 may interface with a connector (not explicitly shown) of the lid 585 to access the bus 592 in which such a connector has circuitry but no memory.

The bottom view of the exemplary lid 585 also illustrates five (5) air inlet interfaces 520 and five (5) ink outlet interfaces 530. The interfaces 520 and 530 may, for the sake of explanation and not limitation, be considered as having four (4) outside interfaces and a single central interface. The four (4) outside air inlet interfaces 520 and ink outlet interfaces 530 may interface with the four (4) air inlet apparatuses 515 and ink outlet apparatuses 525 of the four (4) ink containers 455 (of FIGS. 5D and 5E). The single central air inlet interface 520 and ink outlet interface 530 may interface with the single air inlet apparatus 515 and ink outlet apparatus 525 of the top side of the lid 585 (of FIG. 5G). It should be noted that the single central air inlet interface 520 and ink outlet interface 530 may differ from the four (4) outside air inlet interfaces 520 and ink outlet interfaces 530. The air inlet interfaces 520 are connected by a manifold 594, and the ink outlet interfaces 530 are connected by a manifold 596. Two different (of many possible) manifold designs are illustrated by the manifold 594 and the manifold 596. Specifically, the manifold 594 interconnects the five (5) air inlet interfaces 520 via the five (5) air inlet interfaces 520 themselves. The manifold 596, on the other hand, interconnects the five (5) ink outlet interfaces 530 via a common, but separate, pathway. As another (un-illustrated) alternative, each of the four (4) outside interfaces (520 or 530) may have its own separate pathway to the respective single central interface (520 or 530, respectively).

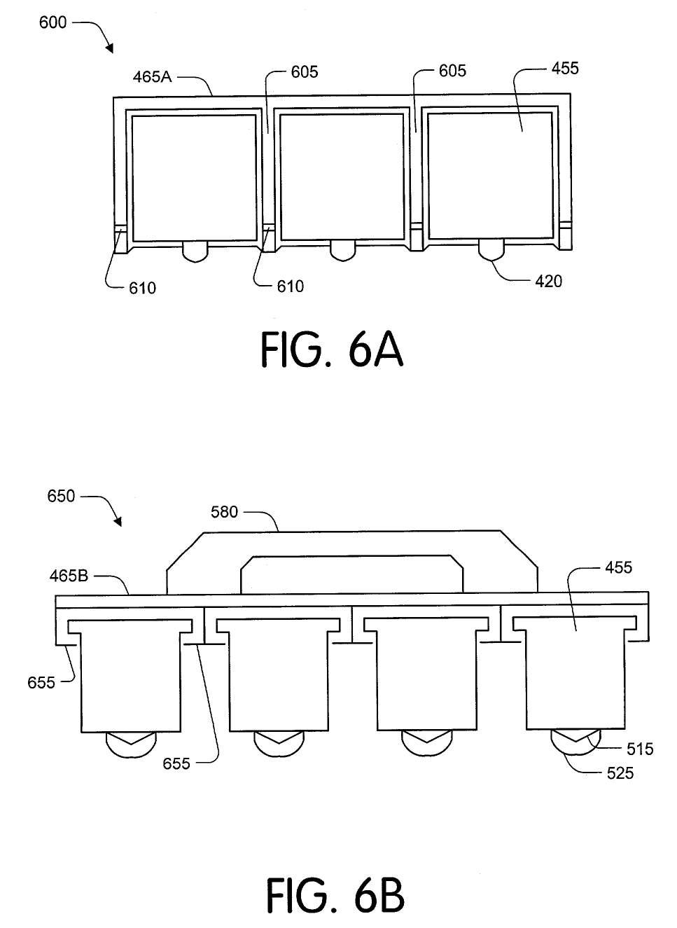

FIG. 6A illustrates generally at 600 a top view of a fourth exemplary multi-hue ink container implementation having another exemplary carrier. The top view of the fourth exemplary multi-hue ink container implementation 600 illustrates a carrier 465A in which three (3) ink containers 455 have been inserted therein from the top and/or front of the carrier 465A. The ink containers 455 each include a fluid coupling apparatus 420, which may optionally extend beyond the confines of the carrier 465A. The carrier 465A may include physical features 605 to maintain the ink containers 455 in a desired spatial relationship with respect to each other. The physical features 605 may extend downward to cover the full height of the carrier 465A (e.g., reaching the bottom thereof), or the physical features 605 may extend downward only sufficiently far so as to contact the sides of the ink containers 455. The physical features 605 may also extend downward to some intermediate length. Located on the carrier 465A are connector features 610 that may be used to secure a lid (e.g., a fully or relatively solid panel, a retaining bar, etc.) to the carrier 465A via, e.g., a plastic snapping mechanism. In the fourth exemplary multi-hue ink container implementation 600, much of the top surface of the carrier 465A is not present (as compared to the carrier 465 of, e.g., FIGS. 4D-4F). It should be noted that, for example, any of the sides of a carrier may be missing (e.g., substituted with a lip from a side corner), replaced with bars or a gridwork, etc. so as to reduce the weight of and/or the materials consumed by the carrier. In other words, the sides need not be solid. As another alternative implementation, a memory chip apparatus 405 may be located directly on a main portion of a carrier 465 with or without a lid portion being included as part of the carrier 465. For example, a memory chip apparatus 405 may be placed on a lower front portion of the carrier 465A (e.g., below the fluid coupling apparatus 420) with the ink containers 455 being lowered (and optionally snapped) into the carrier 465A.

FIG. 6B illustrates generally at 650 a top view of a fourth exemplary single-hue ink container implementation having another exemplary carrier. The top view of the fourth exemplary single-hue ink container implementation 650 illustrates a carrier 465B that holds four (4) ink containers 455, which may have been inserted therein from the top and/or front of the carrier 465B. The ink containers 455 each include an air inlet apparatus 515 and an ink outlet apparatus 525, which may optionally extend beyond the confines of the carrier 465B. The carrier 465B may include physical features 655 to maintain the ink containers 455 in a desired spatial relationship with respect to each other and also optionally to hold the ink containers against the body of the carrier 465B. The physical features 655 may extend downward to cover the full height of the carrier 465B (e.g., reaching the bottom thereof), or the physical features 655 may extend downward only sufficiently far so as to contact the sides of the ink containers 455. The physical features 655 may also extend downward to some intermediate length (e.g., and optionally partially upward from the bottom).

A handle 580 is illustrated as being included with the carrier 465B. The handle 580 may be fixably or removably attached to the carrier 465B, integrated therewith, etc. In the fourth exemplary single-hue ink container implementation 650, the handle 580 is located opposite to the air inlet apparatus(es) 515 and the ink outlet apparatus 525 so that the carrier 465B can be easily lowered into (and raised out of) a printer with the air inlet apparatus(es) 515 and the ink outlet apparatus 525 pointing downward for printers that are designed to receive them from above (e.g., as compared to those designed to receive an ink cartridge fluid coupling apparatus from a side). As described above, the ink containers 455 may be inserted from the front of the carrier 465B. The physical features 655 may “snap” the ink containers 455 into and/or against the carrier 465B. Additionally or alternatively, the carrier 465B may include features on the front wall thereof (opposite the handle 580) with matching features on the adjacent side of the ink containers 455 (opposite the air inlet apparatus(es) 515 and the ink outlet apparatus 525) to attach the carrier 465B to the ink containers 455 and/or to maintain the ink containers 455 in a desired relative alignment.

It should be understood that features specifically and/or only illustrated and/or described in the context of either the single-hue ink container implementation(s) or the multi-hue ink container implementation(s) may be applied to and/or utilized in conjunction with the other implementation(s). For example, ink measurer apparatuses and handles (and various related options and alternatives) may be employed in the context of multi-hue ink container implementation(s), and apertures (and various related options and alternatives) may be employed in the context of single-hue ink container implementation(s). As another example, both of the single-hue ink container implementation(s) and the multi-hue ink container implementation(s) may be applied to and/or utilized in conjunction with fixer ink(s).

It should also be understood that the ink jet cartridge interfaces 435 and 545 may be substituted with laser printer cartridge interfaces for laser printer implementations. Furthermore, “cartridge interface” may represent, embrace, and include both ink jet cartridge interfaces and laser printer interfaces, as well as interfaces for other types of printing devices. Likewise, “ink cartridge” may represent, embrace, and include toner ink cartridges and liquid ink cartridges while “cartridge” may represent, embrace, and include, for example, a carrier and associated ink containers, as well as a single ink container that is mountable on (including in) and interfaceable with a printing device. Additionally, the term “coupling” may represent, embrace, and include a fluid coupling, a liquid coupling, an ink coupling, a toner coupling, an ink outlet/air inlet pair coupling, some combination of these couplings, and so forth.

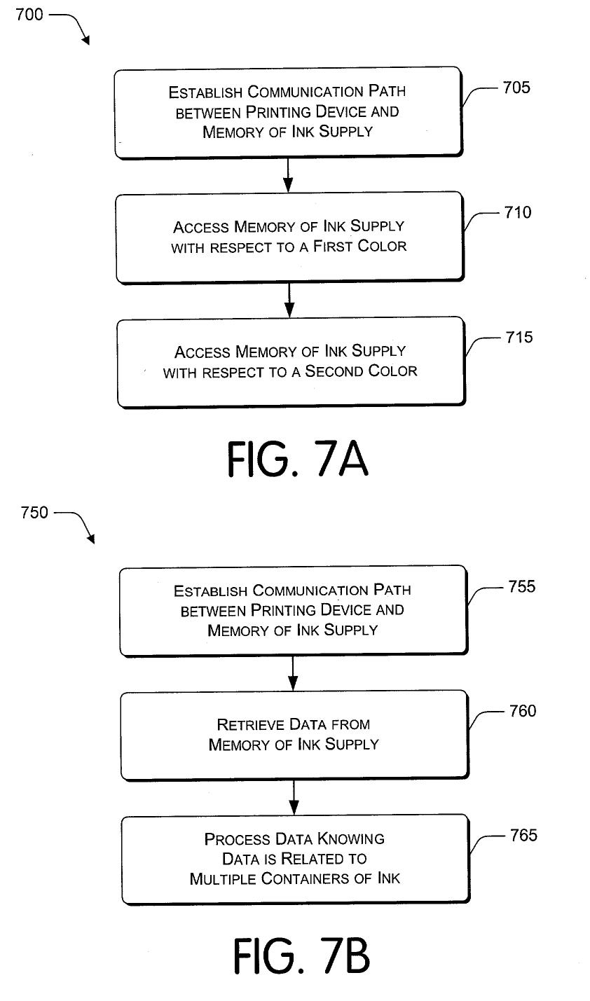

FIG. 7A illustrates generally at 700 an exemplary method in flowchart form for communicating with a memory of an exemplary multi-hue ink container implementation. A communication path may be established between a printing device and a memory of an ink supply (block 705). For example, a memory chip interface of an ink cartridge interface of a printing device may communicate with a memory chip apparatus (e.g., that is located on the carrier or an ink container) of an ink cartridge. The printing device may access the memory of the ink supply with respect to a first color of ink (block 710). For example, the printing device may read the ink level/amount of a given hue held by a particular ink container of the ink cartridge. The printing device may thereafter (or substantially simultaneously if the ink level/amount of more than one color may be requested and/or received over a wider bus and/or a larger communication packet/message) access the memory of the ink supply with respect to a second color of ink (block 715). The printing device may therefore know the ink level/amount of more than one hue from more than one ink container of an ink cartridge by accessing one memory of the ink cartridge.

FIG. 7B illustrates generally at 750 an exemplary method in flowchart form for communicating with a memory of an exemplary single-hue ink container implementation. A communication path may be established between a printing device and a memory of an ink supply (block 755). Data may be retrieved by the printing device from the memory of the ink supply (block 760). The data may include, for example, (i) an ink level/amount for all ink containers of the ink cartridge in total, (ii) an ink level/amount for a single ink container (e.g., with knowledge of the total number of ink containers as a default number, as retrieved from the memory, etc.), (iii) an ink level/amount for each single ink container (e.g., over a single retrieval or over multiple retrievals), (iv) some combination thereof, etc. The printing device may process the data knowing that the data is related to multiple (and optionally the exact number of) ink containers in the ink cartridge (block 765). For example, the printing device may determine a total remaining ink level/amount of the ink cartridge based on multiple ink levels/amounts for multiple ink containers using addition and/or multiplication given the total number of ink containers of the ink cartridge. It should be understood that a memory for any of the relevant described implementation(s) may store information regarding fixer ink(s) as well.

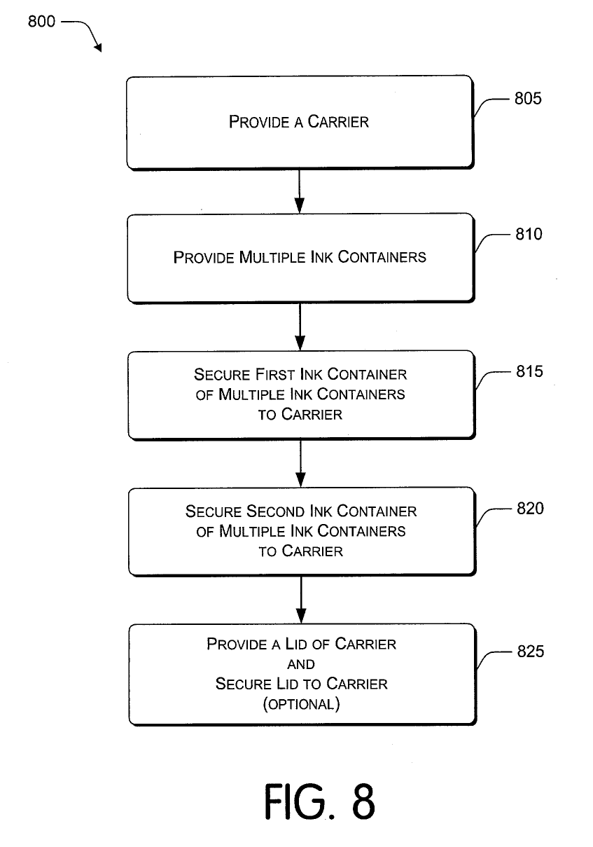

FIG. 8 illustrates generally at 800 an exemplary method in flowchart form for constructing an exemplary ink supply system. The flowchart 800 may be utilized to construct an exemplary ink cartridge having more than one ink container. A carrier capable of supporting (e.g., by securement thereto, by insertion therein, by placement thereon, some combination thereof, etc.) more than one ink container may be provided (block 805). Multiple ink containers may be provided (block 810). These ink containers may be empty or already holding ink when they are provided (at block 810). These ink containers (or other substantially similar ink containers within generally accepted manufacturing tolerance(s)) may be capable of use in a printing device individually or in conjunction with support by a carrier. A first ink container of the multiple ink containers may be secured to the carrier (block 815). The securement (or, more generally, the supporting) of the ink containers may be accomplished in a removable, a fixable, a temporary, a permanent, some combination thereof, etc. fashion. It should be noted that the securing of an ink container to a carrier may include attaching, adhering, inserting, welding, clipping, snapping, connecting, sliding into/onto, some combination thereof, etc.

A second ink container of the multiple ink containers may be secured to the carrier (block 820). It should be understood that the first and second ink containers (and optionally any or all of the multiple ink containers destined to be secured to the carrier) may be secured thereto substantially simultaneously. For example, if the first and second ink containers are inserted (fully or partially) into the carrier, then they may be inserted fully sequentially, partially sequentially, or (at least substantially) simultaneously. After they are inserted (or otherwise supported by the carrier), the first and second ink containers may be juxtaposed together, merely proximate to each other, etc. However, because the first and second ink containers are originally provided as separate, there is a point (if not a line or plane) of discontinuity (e.g., between a plastic wall of the first ink container and a plastic wall of the second ink container, assuming they are formed from plastic) between the first ink container and the second ink container, even if they are pressed closely together. After the first ink container and the second ink container of multiple ink containers have been secured to the carrier (at blocks 815 and 820, respectively), a lid of the carrier may optionally be provided and secured to the carrier (block 825). It should be noted that the ink (whether liquid, toner, and/or fixer ink) for the ink containers may be added before, during, and/or after the construction of the ink cartridge using the carrier. Also, it should be understood that more than two ink containers may be secured to (or otherwise supported by) the carrier.

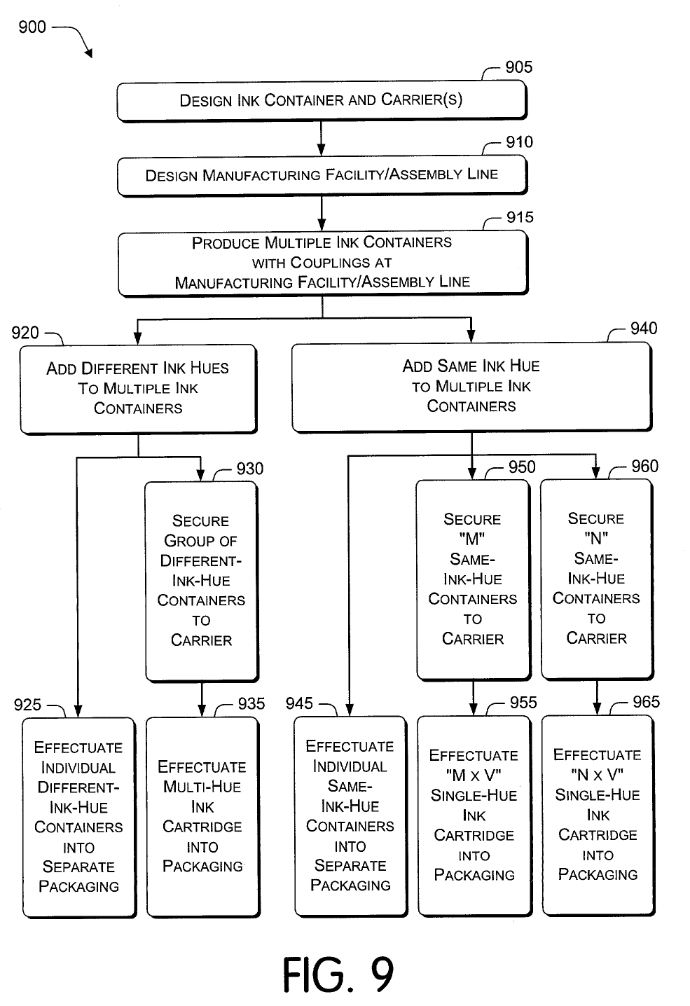

FIG. 9 illustrates generally at 900 an exemplary method in flowchart form for manufacturing exemplary ink supply systems. The flowchart 900 includes the design of an ink container that may be used individually or grouped with other ink container(s) and the design of associated carrier(s) (block 905). The ink containers may be designed so that they are individually mountable on (including in) and interfaceable with a printing device. Similarly, the carrier(s) may be designed so that they, at least when supporting one or more of the ink containers, are also mountable on and interfaceable with a printing device. These designs may be capable of use with existing printing devices, or a printing device may be designed for or in conjunction with the ink containers and/or the carrier(s). Likewise, a manufacturing facility and/or assembly line may be designed (block 910) that can produce the designed ink container, and optionally the designed carrier(s), too. Multiple ink containers with couplings (e.g., ink couplings, fluid couplings, ink outlet/air inlet pair couplings, etc.), and optionally carrier(s), may be produced on the manufacturing facility and/or assembly line (block 915). Different ink hues (and/or fixer(s)) may be added to multiple ink containers (block 920). These ink hues may include one or more of the following: cyan, magenta, black, light-cyan, yellow, green, light-magenta, and orange.

Individual different-ink-hue containers may be effectuated into separate packaging (block 925) for individual sale, for example as ink cartridges having only one ink container. The packaging may be formed from boxes, plastic, etc. Additionally, some of the different-ink-hue containers from the manufacturing facility and/or assembly line may be grouped together and secured to (or, more generally, supported by) a carrier (block 930). Also, and by way of example only, (i) a lid of the carrier may be secured thereto, (ii) a memory chip apparatus may be secured to the carrier, including to the lid, or to a different-ink-hue container, (iii) both of the above may occur, etc. It should be noted that the securement of the group of different-ink-hue containers to the carrier (either a partial or a complete construction of a multi-hue ink cartridge) (e.g., as illustrated by block 930) may occur prior to the addition of the different ink hues to the group of different-ink-hue containers (e.g., as illustrated by block 920). After the multi-hue ink cartridge has been constructed (e.g., as illustrated by block 930), the multi-hue ink cartridge may be effectuated into packaging (block 935) (e.g., into multiple-container ink cartridge packaging).

It should be understood that all implementation(s) do not require that ink containers be produced from the same manufacturing facility and/or assembly line, even within a given multi-hue ink container implementation or a given single-hue ink container implementation. Nevertheless, it is possible for ink containers across both a given multi-hue ink container implementation and a given single-hue ink container implementation to be produced from the same manufacturing facility and/or assembly line. For example, it may be that color ink containers of a volume “V” that adequately service a color printing device may also satisfy the requirements of a printing device using only a single hue of ink when the total ink volume is scaled to “n×V”, where “n” represents the number of ink containers supported by a particular carrier of a particular single-hue ink cartridge. On the other hand, if particular color (e.g., multifunction) printing devices are destined for a consumer market while particular web printers are destined for an industrial market, then the ink volume demands of the industrial market may preclude production or utilization of the same base ink containers for corresponding ink cartridges of the respective markets.

Continuing now with the flowchart 900, after production of multiple ink containers at a manufacturing facility and/or assembly line (at block 915), the same ink hue (e.g., black) (or a fixer) may be added to multiple ink containers (block 940). Individual ones of the same-ink-hue containers may be effectuated into separate packaging (block 945) for individual sale, for example as ink cartridges having only one ink container. Other, “M” and “N” total, same-ink-hue containers (e.g., of a volume “V”) may be secured to a carrier (blocks 950 and 960 respectively). Also, and by way of example only, (i) a lid of the carrier may be secured thereto, (ii) a memory chip apparatus may be secured to the carrier, including to the lid, or to a same-ink-hue container, (iii) both of the above may occur, etc. It should be noted that the addition of the same ink hue may alternatively occur after such securement (e.g., as illustrated in blocks 950 and 960). The “M×V” and “N×V” total volume single-hue ink cartridges may be effectuated into packaging (blocks 955 and 965, respectively) (e.g., into multiple-container ink cartridge packaging). Using such an exemplary modular and adaptable approach to manufacturing exemplary ink supply systems facilitates additional infrastructure extension and/or enhanced market flexibility.

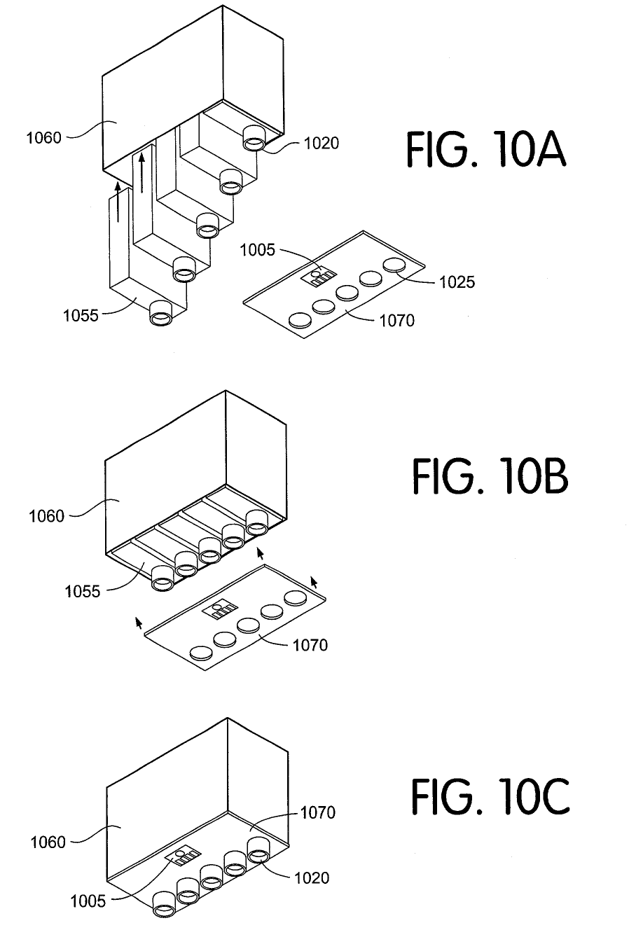

FIGS. 10A, 10B, and 10C are isometric views further illustrating an exemplary embodiment of the invention, in which five discrete ink containers are configured within a carrier. This embodiment may be used in a 6-ink writing system with 5 colors (for example, cyan, magenta, yellow, light-cyan, and light magenta). As shown in FIG. 10A, the five discrete ink containers 1055, each with a fluid interconnect 1020, are placed within carrier 1060. Each of the discrete ink containers 1055 may be essentially identical to ink containers configured for individual use (i.e., in an non-ganged configuration), or may be constructed of components essentially identical to individual containers, such that many of the same manufacturing processes may be used building both individual and ganged configurations. The containers used in ganged configurations may also be somewhat simplified versions of the individual containers (for example, the individual containers may have each have a separate memory component).

FIG. 10B shows the five ink containers fully installed in the carrier 1060 with the lid 1070 positioned for installation on the carrier, and FIG. 10C shows the completed assembly.

Carrier lid 1070 includes holes 1025 permitting each of the fluid interconnects 1020 to pass through the lid when the lid is installed on the carrier. The carrier lid 1070 also includes a memory device 1005, which includes information on each of the five ink containers. The memory device may alternatively be placed on the carrier itself, rather than on the lid. The lid 1070 and carrier 1025 may be configured to be easily assembled, such as by simply snapping together. The invention thus enables having both ganged and individual ink supplies with the addition of only two snap together plastic parts. The fastening of the two plastic parts could be done by many different techniques such as snaps, welding and adhesives.

The present invention thus enables having an ink supply design that can be used across various price points and types of printers. The basic design ink supply can be configured for low cost printers where the initial cost of the printer, including the ink supply, needs to be the lowest cost configuration. The lowest cost configuration would be a ganged configuration, which requires only one memory component for the ganged containers.

On the other hand, many consumers prefer individual supplies, since the potential for wasted residual ink is reduced. Printers may thus be designed to use both ganged and individual ink supplies. The present invention also enables the manufacturer of ink supplies to be easily adjusted to the customer demand between ganged and individual ink supplies without having to redesign the product or the retool manufacturing lines.

Although implementation(s) of apparatuses, methods, systems, and arrangements have been illustrated in the accompanying Drawings and described in the foregoing Detailed Description, it will be understood that the present invention is not limited to the implementation(s) explicitly disclosed, but is capable of numerous rearrangements, modifications, substitutions, etc. without departing from the spirit and scope set forth and defined by the following claims.

What is claimed is:

1. An ink supply system for printing devices, comprising:
a first ink container for holding a first ink, said first ink container including a first fluid coupling;
a second ink container for holding a second ink, said second ink container including a second fluid coupling;
a carrier securing said first and second ink containers, and
a memory apparatus, said memory apparatus configured to store information related to both the first ink and the second ink, the memory apparatus affixed to the carrier.

2. The ink supply system of claim 1, wherein said first ink container and said second ink container are secured to said carrier by at least one of a snap, an adhesive, and a weld.

3. The ink supply system of claim 1, wherein said carrier includes a main body portion and a lid portion, the lid portion of said carrier securing said first ink container and said second ink container to the main body portion of said carrier.

4. The ink supply system of claim 1, wherein the carrier further has a handle.

5. The ink supply system of claim 1, wherein the first ink and the second ink are of different hues.

6. The ink supply system of claim 1, wherein the memory apparatus is configured to store information relating to ink levels in both the first and second ink containers.

7. The ink supply system of claim 1, wherein the memory apparatus is configured to store information indicating the hue of the first and second inks.

8. The ink supply system of claim 1, wherein said carrier includes a main body portion and a lid portion, and said memory apparatus is located on at least one of the lid portion and the main body portion.

9. The ink supply system of claim 1, wherein said carrier includes at least one physical keying feature capable of maintaining said first ink container and said second ink container in a desired spatial relationship.

10. The ink supply system of claim 1, further comprising:
a third ink container, said third ink container including a third coupling and holding a third ink;
wherein said third ink container is supported by said carrier; and the first ink comprises cyan ink, the second ink comprises yellow ink, and the third ink comprises magenta ink.

11. The ink supply system of claim 1, further comprising:
a third ink container, said third ink container including a third coupling and holding a third ink;
a fourth ink container, said fourth ink container including a fourth coupling and holding a fourth ink; and
a fifth ink container, said fifth ink container including a fifth coupling and holding a fifth ink;
wherein said third ink container, said fourth ink container, and said fifth ink container are supported by said carrier; and the first ink comprises cyan ink, the second ink comprises yellow ink, the third ink comprises magenta ink, the fourth ink comprises light-cyan ink, and the fifth ink comprises light-magenta ink.

12. The ink supply system of claim 1, further comprising:
a third ink container, said third ink container including a third coupling and holding a third ink; and
a fourth ink container, said fourth ink container including a fourth coupling and holding a fourth ink;
wherein said third ink container and said fourth ink container are supported by said carrier; and the first ink, the second ink, the third ink, and the fourth ink comprise black ink.

13. The ink supply system of claim 1, further comprising:
a third ink container, said third ink container including a third coupling and holding a third ink;
wherein said carrier is adapted for attachment to and operation with a printing device and is capable of supporting said third ink container; and
said first ink container, said second ink container, and said third ink container are substantially-similarly shaped such that each is adapted also for individual attachment to and operation with the printing device.

14. The ink supply system of claim 1, wherein said carrier includes a main body portion and a lid portion; the lid portion including an external coupling on an external side of the lid portion facing away from said first ink container and said second ink container, a coupling interface on an internal side of the lid portion facing toward said first ink container and said second ink container, and at least one manifold on the internal side of the lid portion that links to at least one of the first coupling of said first ink container and the second coupling of said second ink container.

15. The ink supply system of claim 1, wherein said first ink container further includes a first ink measurer apparatus, and said second ink container further includes a second ink measurer apparatus.

16. An ink cartridge for a printing device, comprising:
a carrier, said carrier having at least a first side and a second side;
a first ink container, said first ink container having at least a first end and a second end; the first end of said first ink container including a fluid coupling, and the second end of said first ink container being secured to the first side of said carrier; and
a second ink container, said second ink container having at least a first end and a second end; the first end of said second ink container including a fluid coupling, and the second end of said second ink container being secured to the first side of said carrier.

17. The ink cartridge for a printing device of claim 16, further comprising:
a handle, said handle secured to or integral with the second side of said carrier.

18. The ink cartridge for a printing device of claim 16, wherein a first ink held by said first ink container and a second ink held by said second ink container comprise the same hue.

19. The ink cartridge for a printing device of claim 18, wherein the same hue comprises black.

20. An ink cartridge for a printing device, comprising:
a carrier, said carrier capable of receiving a plurality of ink containers, said carrier including a lid secured thereto;
a first ink container, said first ink container including a first ink outlet apparatus, a first air inlet apparatus, and a first ink measurer apparatus;
said first ink container being at least partially inserted into said carrier; and
a second ink container, said second ink container including a second ink outlet apparatus, a second air inlet apparatus, and a second ink measurer apparatus; said second ink container being at least partially inserted into said carrier.

21. The ink cartridge for a printing device of claim 20, wherein said carrier forms a box for supporting said first ink container and said second ink container.

22. The ink cartridge for a printing device of claim 20, further comprising:
at least one memory chip apparatus, said at least one memory chip apparatus storing at least one indicator related to at least one of an ink level and an ink amount held by the ink cartridge.

23. The ink cartridge for a printing device of claim 22, wherein said at least one memory chip apparatus comprises an integrated circuit.

24. The ink cartridge for a printing device of claim 22, wherein said at least one memory chip apparatus is located on at least one of (i) said carrier, including the lid, (ii) said first ink container, and (iii) said second ink container.

25. The ink cartridge for a printing device of claim 22, wherein the lid includes at least one aperture to provide access to at least one of the first ink outlet apparatus, the first air inlet apparatus, the first ink measurer apparatus, the second ink outlet apparatus, the second air inlet apparatus, and the second ink measurer apparatus.

26. The ink cartridge for a printing device of claim 22, wherein the lid includes at least one ink manifold in ink communication with the first ink outlet apparatus and the second ink outlet apparatus and at least one air manifold in air communication with the first air inlet apparatus and the second air inlet apparatus.

27. The ink cartridge for a printing device of claim 26, wherein the lid includes on an external side of the lid an ink outlet apparatus that is in ink communication with the at least one ink manifold and an air inlet apparatus that is in air communication with the at least one air manifold.

28. The ink cartridge for a printing device of claim 22, wherein the lid includes at least one line in electromagnetic communication with the first ink measurer apparatus and the second ink measurer apparatus.

29. An ink cartridge for a printing device, comprising:
a carrier, said carrier capable of receiving a plurality of ink containers, said carrier including a lid portion;
a first ink container, said first ink container including a first fluid coupling and holding an ink of a first hue;
a second ink container, said second ink container including a second fluid coupling and holding an ink of a second hue; and
a third ink container, said third ink container including a third fluid coupling and holding an ink of a third hue;
wherein the first hue, the second hue, and the third hue comprise different hues; and said first ink container, said second ink container, and said third ink container are at least partially inserted into said carrier.

30. The ink cartridge for a printing device of claim 29, further comprising:
a handle, said handle at least one of secured to and integral with said carrier.

31. The ink cartridge for a printing device of claim 29, wherein the first hue comprises cyan, the second hue comprises magenta, and the third hue comprises yellow.

32. The ink cartridge for a printing device of claim 29, further comprising:
a fourth ink container, said fourth ink container including a fourth fluid coupling and holding an ink of a fourth hue; and
a fifth ink container, said fifth ink container including a fifth fluid coupling and holding an ink of a fifth hue;
wherein the first hue, the second hue, the third hue, the fourth hue, and the fifth hue comprise different hues; and said fourth ink container and said fifth ink container are at least partially inserted into said carrier.

33. The ink cartridge for a printing device of claim 32, wherein the first hue comprises cyan, the second hue comprises light-magenta, the third hue comprises yellow, the fourth hue comprise light-cyan, and the fifth hue comprises magenta.

34. The ink cartridge for a printing device of claim 29, wherein the lid portion of said carrier is secured to a main body portion of said carrier.

35. The ink cartridge for a printing device of claim 29, wherein the lid portion includes at least one aperture for providing access to the first fluid coupling, the second fluid coupling, and the third fluid coupling.

36. The ink cartridge for a printing device of claim 35, wherein the at least one aperture of the lid portion further comprises a first fluid coupling aperture, a second fluid coupling aperture, and a third fluid coupling aperture; and wherein the first fluid coupling aperture provides access to the first fluid coupling, the second fluid coupling aperture provides access to the second fluid coupling, and the third fluid coupling aperture provides access to the third fluid coupling.

37. The ink cartridge for a printing device of claim 29, wherein the lid portion includes at least one memory chip apparatus.

38. The ink cartridge for a printing device of claim 37, wherein the at least one memory chip apparatus includes a first ink level/amount indication for the ink of the first hue, a second ink level/amount indication for the ink of the second hue, and a third ink level/amount indication for the ink of the third hue.

39. An ink supply system for increased ink supply modularity, comprising:
means for supporting a plurality of ink containers;
first means for holding ink, said first means for holding ink including first means for coupling ink;
second means for holding ink, said second means for holding ink including second means for coupling ink;
means for storing information related to said first means for holding ink and said second means for holding ink; and
wherein said means for supporting a plurality of ink containers supports said first means for holding ink and said second means for holding ink.

40. The ink supply system of claim 39, wherein said means for supporting a plurality of ink containers includes means for covering, said means for covering at least partly covering said first means for holding ink and said second means for holding ink.

41. The ink supply system of claim 40, wherein said means for storing information related to said first means for holding ink and said second means for holding ink is disposed on the means for covering.

42. A method of constructing an ink cartridge for an ink supply system, comprising:
gathering a plurality of discrete ink containers and an ink container carrier;
inserting, at least partially, the plurality of ink containers into the carrier;
securing the plurality of ink containers to the carrier to form an assembled cartridge; and
securing a memory apparatus to the assembled cartridge, the memory apparatus configured to contain information related to each of the discrete ink containers.

43. The method of claim 42, wherein said step of securing the plurality of ink containers to the carrier comprises the step of snapping the plurality of ink containers onto the carrier.

44. The method of claim 42, further comprising the step of:
storing on the memory apparatus indicators regarding ink level for each of the plurality of ink containers.

45. A method of constructing an ink cartridge, comprising the steps of:
providing a carrier, including a lid for the carrier;
providing a plurality of discrete ink containers, each ink container of the plurality of ink containers including an ink coupling, the plurality of ink containers including at least a first ink container and a second ink container;
inserting, at least partially, the first ink container into the carrier;
inserting, at least partially, the second ink container into the carrier;
securing the lid to the carrier, the lid thereby at least partly covering the first ink container and the second ink container; and
securing at least one memory chip apparatus to the lid.

46. The method of claim 45, wherein the at least one memory chip apparatus stores first information related to the first ink container and second information related to the second ink container.

47. The method of claim 45, wherein said step of securing the lid to the carrier comprises the step of:
connecting respective interfaces of a plurality of interfaces of the lid to respective ink couplings of the first ink container and the second ink container.

48. The method of claim 45, wherein each ink container of the plurality of ink containers is adapted to be individually mountable on and operably interfaceable with a particular printing device design; and wherein each multiple-container ink cartridge of the plurality of multiple-container ink cartridges is adapted to be mountable on and operably interfaceable with the particular printing device design.
